(19) United States
(12) Patent Application Publication
(10) Pub. No.: US 2008/0098074 A1
(43) Pub. Date: Apr. 24, 2008

(54) Method and Apparatus for Motivation Enhancement

(76) Inventor: Robert Hurling, Sharnbrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/666,798

(22) PCT Filed: Nov. 3, 2005
(86) PCT No.: PCT/US05/40413

§ 371 Date: May 1, 2007

(30) Foreign Application Priority Data
Nov. 3, 2004 (EP) 04256794.1

(51) Int. Cl. G06F 15/16

(52) U.S. Cl. 709/206

(57) ABSTRACT

An automated method for boosting and/or maintaining a sense of well being of a person an automated method and apparatus assists individuals in regularly breaking out of immediate stressful situations which may otherwise contribute to long term deterioration in their health, well-being and/or vitality. The method is implemented by a data processing device and includes (a) sending an initiation message to the user requesting an indication of a sense of well being of the user; (b) receiving, from the user, a quantitative indication of the user's sense of wellbeing; and (c) based on the received quantitative indication, sending to the user at least one instruction message indicating an activity to be implemented by the user.

The present invention relates to methods and apparatus for boosting motivation, vitality and a sense of well being of a plurality of persons.

Many people are continually striving to find new, effective and entertaining ways of improving their quality of life and generally their sense of well being and happiness. Still further, many people are also trying to avoid over-stressful lifestyles and build up of tension that can be damaging to their long-term health. A problem that exists for a substantial number of people in this category is that in busy, intense or stressful environments, such as at a workplace or at home, they may be too distracted or otherwise involved in their immediate situation to recognise that their general state of well-being might be improved with an immediate, spontaneous diverting activity that could defuse immediate tension and reduce stress levels.

It is an object of the present invention to provide an automated method and apparatus to assist individuals in regularly breaking out of immediate stressful situations which may otherwise contribute to long term deterioration in their health, well-being and/or vitality.

It is a further object of the invention to provide an entertaining, convenient and effective way of achieving the above for one or many persons, individually or collectively.

According to one aspect, the present invention provides an automated method for boosting and/or maintaining a sense of well being of a person comprising:

(a) sending an initiation message to the user requesting an indication of a sense of well being of the user;

(b) receiving, from the user, a quantitative indication of the user's sense of well-being; and

(c) based on the received quantitative indication, sending to the user at least one instruction message indicating an activity to be implemented by the user.

According to another aspect, the present invention provides apparatus for boosting and/or maintaining a sense of well being of a person comprising a data processing apparatus adapted to carry out the steps (a), (b) and (c) above.

Embodiments of the invention will now be described by way of example and with reference to the accompanying drawings in which:

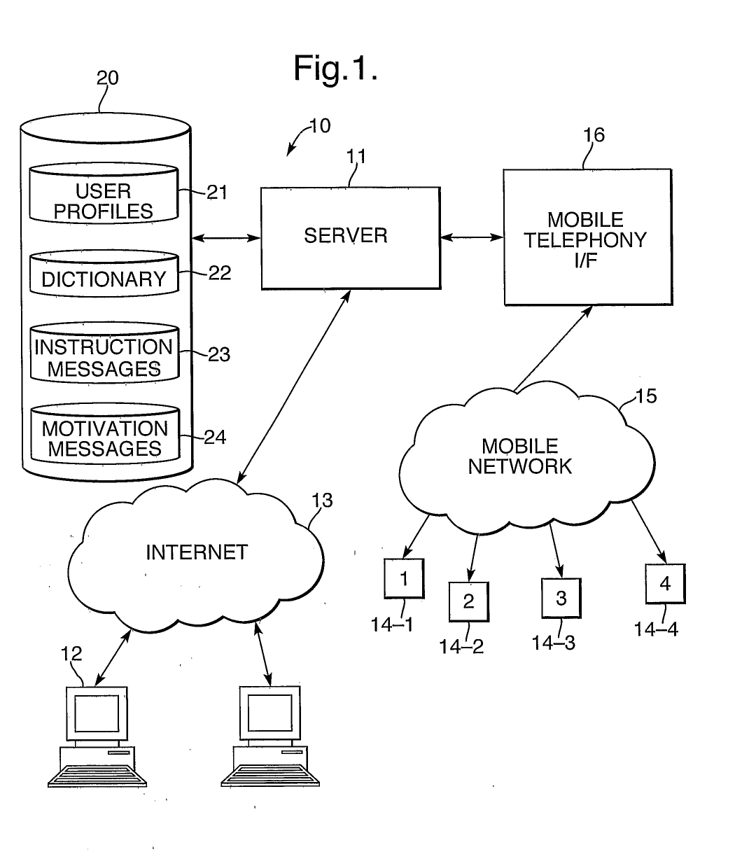

FIG. 1 shows a schematic diagram of apparatus for implementing an automated method of boosting and/or maintaining a sense of well-being of a number of persons; and

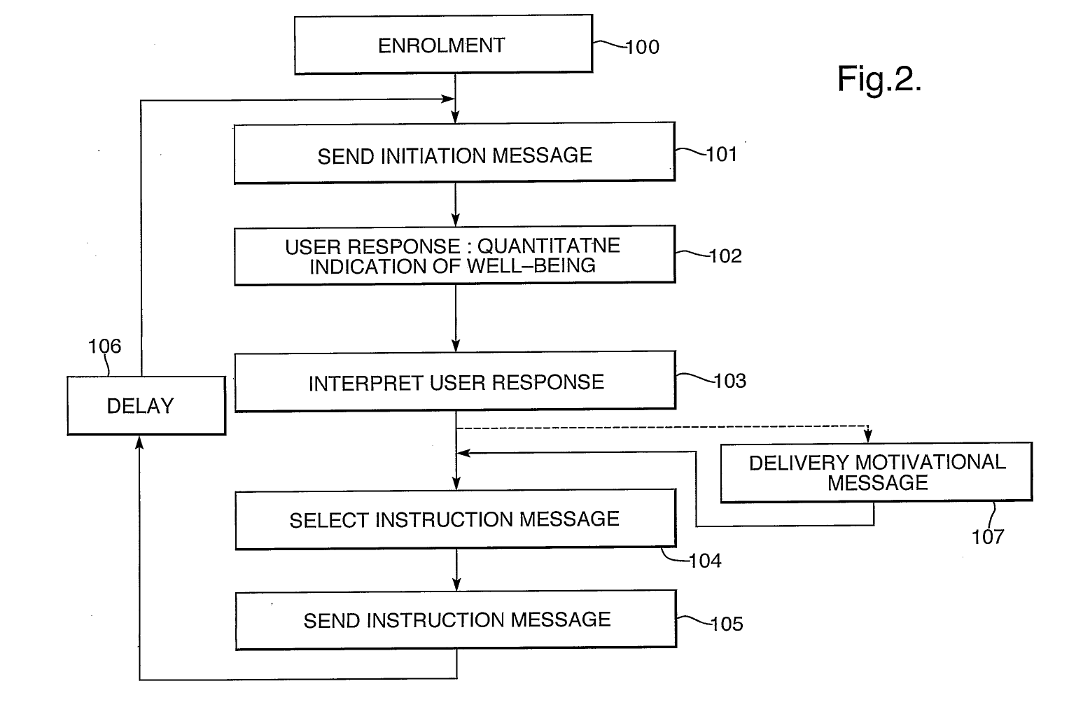

FIG. 2 is a flowchart illustrating a procedure for the method of boosting and/or maintaining a sense of well being of a targeted individual.

Throughout the present specification, the expression ‘a sense of well-being’ is intended to encompass a user's perception of his or her own mental, emotional and/or physical state or condition, which may also encompass the user's perception of his or her ‘vitality’. The user's perception of vitality preferably includes a subjective or objective measure of their general state of health and/or happiness.

With reference to FIGS. 1 and 2, a preferred automated method for boosting and/or maintaining a sense of well being of a person is now described.

A prospective user of an automated ‘vitality boosting’ system 10 first enrolls as a user of the system (step 100). In the preferred arrangement, the enrollment is performed by on-line access to server 11 using a personal computer 12 connected to the server 11 by suitable communications network 13, such as the internet.

The enrollment process (step 100) may include the selection, by the user, of an immediate form of electronic communication with the user for the delivery of messages from the server 11 to the user, and for delivery of responses from the user to the server. For most users, the selected form of communication will be their mobile telephone 14 using the cellular telephone network 15 and a mobile telephony interface 16 between the server 11 and the network 15. Alternatively, the form of electronic communication to be used may be directly inferred, if the system is designed exclusively for implementation on a mobile telephony-based text messaging service. The enrollment process typically includes provision of a user's mobile telephone number to the server 11.

The enrollment process may also include the gathering of personal data identifying attributes of the user to be included in a user profile database 21. The user profile may include information identifying a user's character, lifestyle, social grouping, preferred style of communication, emotional, physical, psychological and/or mental condition. More generally, this information will be referred to as user profile parameters. This information may be acquired by way of a dialogue with the user to determine any appropriate form and/or category of messages delivered to the user by the server 11, as will be explained later. The user profile may also contain user preferences directly selected by the user as will be explained later. The user profile may include information derived from previous interactions with the system, as will be explained later.

Once a user is enrolled onto the system, the server 11 will send, at predetermined or non-predetermined intervals, an initiation message to the user (step 101). The initiation message generally comprises a request for the user to indicate a sense of well being of the user. The initiation message may be as simple and straightforward as the request “How are you feeling right now?”, or “How vital are you feeling?”, or “How would you rate your present state of health and happiness on a scale of 1 to 10?”.

In response to the initiation message, the user is invited to respond with a quantitative indication of their perceived sense of well being (step 102). Throughout the present specification, the expression ‘quantitative indication’ of a user's sense of well-being refers to an indication that is selected from at least two or more discrete distinguishable states either: (i) expressed on a numerical scale (e.g. 1 to 10); (ii) expressed as a relative semantic scale (e.g. very low, low, medium, good, excellent etc); or (iii) expressed as a plurality of descriptive phrases or words indicating a selection of varying mental, emotional or physical conditions (e.g. ‘exhausted’, ‘tired’, ‘sad’, ‘happy’, ‘demotivated’, ‘exhilarated’, ‘too busy’, ‘a bit stressed’ etc).

In a preferred embodiment, the user simply responds by texting, to the server 11, a number on the scale of 1 to 7 with 1 signifying ‘not very vital at all’ and 7 signifying ‘very vital’. In another embodiment, the user simply responds with a word from a predetermined relative semantic scale such as low, medium, high etc.

In another, more sophisticated embodiment, the user may be permitted to text back any word or phrase which best summarises his or her present mental, physical or emotional state.

When the server receives the user's response, the server 11 sends an instruction message (step 105), based on the received quantitative indication, which instruction message indicates an activity to be implemented by the user. The server 11 selects the instruction message (step 104) from an instruction message database 23 according to the received quantitative indication of the user's sense of well being. The server 11 may also select the instruction message according to information contained within the user profile database 21.

Where the quantitative indication is a simple numeric or semantic scale response, the server 11 may select the instruction message from the instruction message database 23 based on a simple relationship of numeric/semantic scale response to instruction message. Preferably, there are many possible instruction messages each corresponding to a particular quantitative indication of well being. The particular instruction message selected from the many possible options for a given quantitative indication may be determined on a random basis or on a cyclic basis. Alternatively, the instruction message may be selected according to past experience derived from previous interactions with the same or other users, e.g. selecting instruction messages in an order of priority according to previously determined levels of efficacy.

Where the quantitative indication takes the form of a descriptive word or phrase, the server 11 first interprets the user's response (step 103) to determine a set of possible instruction messages that are appropriate to that response. In such an embodiment, the server 11 will include a dictionary 22 or ‘look-up’ table that is used to identify key words, key phrases or key words within phrases and to establish a group of instruction messages that are appropriate to the key word, key words or phrase. A specific instruction message can then be selected from that group on a random, cyclic or experience basis as discussed above.

The instruction messages each indicate at least one activity to be implemented by the user. The activity may be selected from one or more of: (i) a physical activity; (ii) a mental activity; (iii) a therapeutic activity; and (iv) a social activity.

Thus, in a first embodiment, a user response giving a quantitative indication of well being that is relatively low in a scale may trigger the sending of an instruction message selected from the following examples.
a) “Take a break! Do something different for a while and you will feel much more vital.”
b) “Get a drink, sit down and relax—you need it.”
c) “Stretch your legs. A short walk will bring you back to life.”
d) “Look up, open your eyes and mouth wide and stick your tongue out!”
e) “Pretend you are a punk: jump up and down a few times.”
f) “Slap yourself gently or splash your face with cold water.”
g) “Breathe deeply and slowly in through your nose and out through your mouth five times.”

A user response giving a quantitative indication of well being that is fairly average or non-committal in a scale may trigger the sending of an instruction message selected from the following examples.
a) “Ask a colleague to tell you the most exciting thing that has happened to them recently.”
b) “Decide you're going to feel even more vital and find a way to achieve it.”
c) “Look around you, find something funny and smile. Ad again, and again!”
d) “Phone a friend or partner, or find a colleague, and have a gossip.”
e) “Find something to read and really focus on it.”
f) “Gaze at something natural (e.g. a tree or a flower) and marvel at its beauty.”
g) “Eat something really slowly and savour the flavour—then tell someone else about it!”

A user response giving a quantitative indication of well being that is relatively high in a scale may trigger the sending of an instruction message selected from the following examples.
a) “Share it around! Tell someone else how good you feel and why.”
b) “You're a role model—congratulate yourself!”
c) “Hello Dr Vital! Analyse what's making you feel good and get some more!”
d) “Show people how vital you feel in the way you walk and talk.”
e) “List the top three things that make you feel vital and compare with a colleague.”
f) “You're a vitality expert. Find someone with a lower score and help them up.”
g) “Find someone you know well, give them a hug and tell them why!”

It will be understood that the selection of whether an instruction message comprises a physical activity instruction, a mental activity instruction, a therapeutic activity instruction or a social activity instruction may be made on the basis of the user's quantitative indication of their sense of well being. For example, the server 11 may be programmed to recognise certain key words or word patterns used in the quantitative indication as suggesting that a physical activity is most appropriate. Alternatively, a key word used in the user's response may suggest that a mental activity is most appropriate. The selection of the message may also be determined according to the user profile which suggests whether they are an outgoing, extrovert type of person, or an introverted type of person.

After an instruction message has been sent to the user (step 105), the system then loops back to step 101 to send a further initiation message after an appropriate delay (step 106), and to proceed with each of steps 101 to 105 again. Preferably, the delay 106 is determined according to a random or semi-random function so that initiation messages are delivered at irregular and somewhat unpredictable times. The delay may be computed within predetermined limits so that a user is not interrupted with messages too close in succession, but also the delay is not so great as to result in the user obtaining little benefit from the interactions with the system.

The delays 106 between each successive message cycle (steps 101 to 105) may be determined according to a more sophisticated algorithm. For example, message cycles may be grouped in pairs so that the effects of an instructions message can be quickly assessed. The message cycles may be selected to occur during certain times of the day predetermined by the user to correspond to the most stressful or active times of the day, or to coincide with, for example, the working day. The delays may be computed to ensure that message cycles do not occur at excluded parts of the day, e.g. overnight, or when the user does not wish to receive such messages. All of these parameters may be determined for an individual user and stored in the user profile 21.

The system may be configured to increase the frequency of message cycles when the user responses are indicative of a low level of the user's sense of well being or vitality. The frequency may be decreased when the user responses are indicative of a high level of the user's sense of well being or vitality.

The system may be generally configured to use feedback from the user to determine the relevance of instruction messages and the optimum message frequency and timing for individual users or groups of users with similar user profiles. The feedback may include biometric feedback, derived from an automated heart rate monitor or other physiological monitoring system useful as an indicator of well being. This may assist in determining the impact of the instruction messages relative to periods of rest or non-use of the system.

The system may be adapted to include motivational messages to make the system appear more responsive to the user. For example, after receiving a user response (step 102) and interpreting the response, the system may determine the effects of a previous instruction message by assessing the change in user response from one message cycle to a subsequent message cycle, and deliver an appropriate motivation message (step 107) as a result. The motivation message is selected from a database of motivation messages 24. The selection of motivation message preferably takes into account at least one previous user response and the most recent user response. The selection of motivation message may take into account a longer term history of user responses. For example, if the system determines that the user response has indicated an improvement in perceived well being over successive message cycles, an appropriate motivation message may comprise “Well done—you're feeling more vital!”.

In a preferred configuration, the sending of a motivation message 107 for a given message cycle is combined with the sending of an instruction message (step 105) in a combined message. For example, if the system interprets an improvement of user response from a low level to an intermediate level as discussed above, an appropriate combined message might be “Well done—you're feeling more vital! Now look around you, find something funny and smile.” Similarly, if the system interprets an improvement of user response from an intermediate level to a high level as discussed above, an appropriate combined message might be “You're in the top vitality group now. Share it around! Tell someone else how good you feel and why.”

In the reverse situation, if the system interprets a deterioration in user response from a relatively high level to an intermediate level, a motivational message might be “Don't let vitality drain away.” A deterioration in user response from an intermediate level to a low level might trigger a motivational message such as “Watch out, you're in the vitality lowland.” A deterioration in user response from a relatively high level to a relatively low level might trigger a motivational message such as “Watch out! You've crash landed into the lowest vitality group.” An improvement in user response from a relatively low level to a relatively high level might trigger a motivational message such as “Wow! You've rocketed into the highest vitality group.”

Where the system is taking into account a longer term history of user responses, motivational messages might be selected according to whether a longer term downward trend occurs (e.g. a combined message “Recall that feeling of vitality you had, and find a way to bring it back.”) or whether the user has been stuck at an intermediate level for some time (e.g. “Who wants to be average? Find someone with a higher score and ask them how they do it.”).

The system 10 is preferably configured to operate for a plurality of users (e.g. 14-1 to 14-4 in FIG. 1) simultaneously. The users may all be persons in a common environment or location, e.g. a single office or workplace, such that all persons in the environment can participate together. Alternatively, the system 10 can be offered to users from many different locations, who may or may not be associated with one another.

Where a number of users are all present in a common location, the system 10 is preferably configured to send initiation and instruction messages to individual users at different times so that not everyone attempts to perform indicated activities at the same time.

The system 10 may log the responses of plural users and obtain aggregate data as to the general sense of well being of predetermined groups of users. This function could be used to track the levels of motivation and vitality of individual groups of workers in one work place for comparison. Similarly, the motivation and vitality levels of persons in different environments can be tracked and compared.

The style of some or all types of message, i.e. initiation messages, instruction messages, motivation messages and combined messages may be determined or selected according to a user profile that determines the most appropriate form of communication for that user according to their personality type, e.g. dominant or submissive. This may help to make the messages for persuasive and successful for individual types of user.

The system may include a learning engine which can, on a continuous or periodic basis, adapt the system knowledge of, for example: (1) which kinds of user, according to the user profile, react most favourably to which kinds of instruction messages and/or motivational messages; (2) which elements of a user profile are the most appropriate or useful in selecting instruction messages and/or motivational messages; (3) how to use user interaction history to further optimise message selection and elicit more useful feedback from users.

More generally, the learning engine adapts and improves the system knowledge of the relationships between user profile parameters, instruction messages and/or motivational messages and the effectiveness thereof in improving a user's sense of well being.

Other embodiments are within the scope of the appended claims.

1. An automated method for boosting and/or maintaining a sense of well being of a person comprising:
(a) sending an initiation message to the user requesting an indication of a sense of well being of the user;
(b) receiving, from the user, a quantitative indication of the user's sense of well-being; and
(c) based on the received quantitative indication, sending to the user at least one instruction message indicating an activity to be implemented by the user.

2. The method of claim 1 further including repeating steps (a), (b) and (c) at intervals and logging the sense of well being of the user over a period of time.

3. The method of claim 2 wherein the intervals are irregular.

4. The method of claim 2 further including the step of determining whether the sense of well-being of a user improves, declines or stays stable over the period of time.

5. The method of claim 4 further including the step of sending at least one motivational message to the user based on previous and/or current indications of the user's sense of well being.

6. The method of claim 4 in which the step of sending to the user at least one motivational message is combined with the step of sending to the user at least one instruction message, together providing a combined message.

7. The method of claim 4 wherein the frequency of the intervals is determined based on the received indications of the user's sense of well being.

8. The method of claim 1 in which the instruction message comprises an instruction to perform one or more of: (i) a physical activity; (ii) a mental activity; (iii) a therapeutic activity; and (iv) a social activity.

9. The method of claim 1 further including sending a status message to the user based on previous and/or current indications of the user's sense of well being.

10. The method of claim 9 in which the status message indicates the user's status relative to other users of a system implementing the method.

11. The method of claim 1 in which the messages are sent by a mobile telephone network.

12. The method of claim 11 in which the user responses are received from the mobile telephone network.

13. The method of claim 1 further including determining the nature or style of any or all of the instruction message, motivational message and status message according to a user profile.

14. The method of claim 2 further including the step of ascribing a user to a particular group of users of a system implementing the method based on responses received from the user.

15. The method of claim 1 further including the step of selecting an instruction message based on a system database indicating relationships between user profile parameters and instruction message properties and the effectiveness thereof in improving a user's sense of well being.

16. The method of claim 5 further including the step of selecting a motivational message based on a system database indicating relationships between user profile parameters and motivational message properties and the effectiveness thereof in improving a user's sense of well being.

17. The method of claim 15 further including the step of updating the system database using a learning engine that adapts and improves the system knowledge of the relationships between user profile parameters and messages and the effectiveness thereof in improving a user's sense of well being.

18. Apparatus for boosting and/or maintaining a sense of well-being of a person comprising a data processing apparatus adapted to carry out the steps of claim 1.
